(19) United States
(12) Patent Application Publication
(10) Pub. No.: US 2009/0034415 A1
(43) Pub. Date: Feb. 5, 2009

(54) WIRELESS COMMUNICATIONS DEVICE

(75) Inventors: JOHN R. BARR, DEER PARK, IL (US); MARK R. BRAUN, ARLINGTON HEIGHTS, IL (US); EDGAR H. CALLAWAY, JR., BOCA RATON, FL (US); SCOTT B. DAVIS, WALWORTH, WI (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/830,118

(22) Filed: Jul. 30, 2007

(51) Int. Cl. H04L 12/26

(52) U.S. Cl. 370/235

(57) ABSTRACT

A wireless communication device (100) including a high-speed data buffer coupled to a first transceiver by a bus, and an application processor having a data buffer associated with the application processor. The associated data buffer is coupled to a high-speed data buffer and to a second transceiver by the bus, wherein the application processor is configured to control the transfer of data between the associated data buffer and the high-speed data buffer and to control the transfer of data between the associated data buffer and the second transceiver.

### FIELD OF THE DISCLOSURE

The present disclosure relates generally to wireless communications, and more specifically to optimizing the use of high-speed data transfers in transceiver devices having relatively high and low speed data transfer capabilities, for example, in a wireless communication handset.

### BACKGROUND

In some wireless communication systems, a high-speed transceiver is capable of transferring information at a greater rate than a host device can consume or generate the information. While a higher speed transceiver tends to use less energy per unit of information, e.g., per bit, transferred in comparison to a lower speed transceiver, the prolonged operation of the higher speed transceiver and the associated high-speed memory may adversely affect its average power consumption. Also, power consumption in a high-speed transceiver may be wasteful, for example, in instances where the high-speed memory is starved of data or is overloaded with data resulting from limitations of the host device.

U.S. Pat. No. 6,137,789 to Honkasalo entitled “Mobile Station Employing Selective Discontinuous Transmission For High-speed Data Services in CDMA Multi-Channel Reverse Link Configuration” discloses a mobile station that controls a transmission data rate over multiple parallel code channels by disabling and re-enabling transmission over at least one of the parallel channels. In U.S. Pat. No. 6,137,789, a base station assigns a fundamental code channel for the duration of the connection time and a supplemental channel for high-speed data traffic based on how much data is buffered in the mobile station.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic for a wireless communication device.

FIG. 2 is an alternative wireless communication device.

FIG. 3 is another alternative wireless communication device.

FIG. 4 is a process flow diagram.

### DETAILED DESCRIPTION

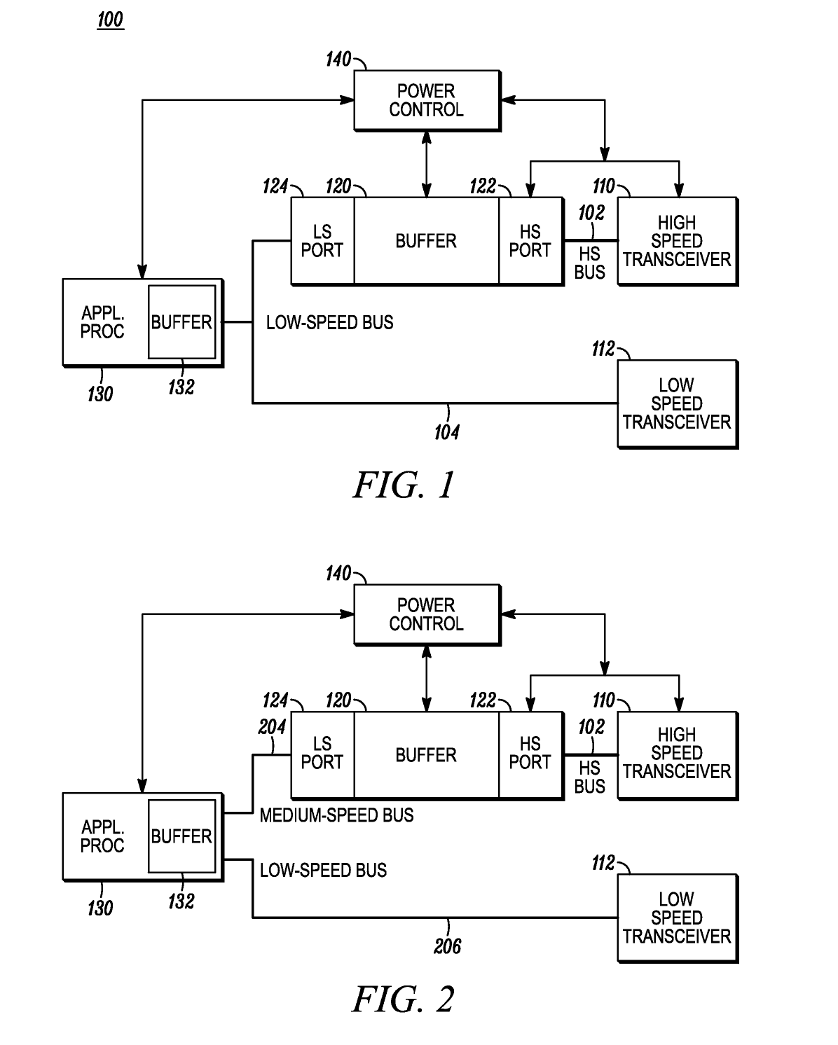

FIG. 1 illustrates a portable wireless communication device 100 comprising first and second transceivers 110 and 112. The first transceiver is a relatively high-speed transceiver, for example, an ultra wideband (UWB) radio transceiver, or an 802.11 compliant transceiver or a millimeter wave (MMW) transceiver. The second transceiver is a relatively low speed device, for example, a Bluetooth compliant transceiver or an infrared, e.g., IrDA, transceiver. Alternatively, wither or both of the first and second transceivers could be implemented as an ultrasound transceiver. In one embodiment, the first and second transceivers communicate data at rates that are differentiated by at least one order of magnitude. In one implementation, for example, the first transceiver communicates on the order of 100 M bit/s and the second transceiver communicates on the order of 1 M bit/s. These data rates are merely exemplary and are not intended to be limiting. In one embodiment, the device 100 is embodied as a portable communications handset or as some other portable communications device. In these and other implementations, the device 100 will also likely include a user interface including, for example, audio inputs and outputs, a video output, and a keypad among other user interface elements.

In FIG. 1, a high-speed (HS) data buffer 120 is coupled to the first transceiver by a bus, for example, a HS data bus 102. The HS data buffer 120 has a high-speed data interface or port 122 to which the HS bus is coupled. The HS data buffer also has a low-speed (LS) port 124 to which a relatively LS bus 104 is coupled. The LS bus is typically coupled to an application processor or other device as discussed further below. Alternatively, the HS data buffer may be interfaced to a multi-drop bus by a single port. The multi-drop bus may operate at different data rates, for example, a HS data rate when communicating with the HS transceiver and a relatively low data rate when communicating with other entities, for example, the application processor discussed further below.

In FIG. 1, the device 100 comprises an application processor 130 having an associated data buffer 132. The data buffer 132 may be integrated with the processor as illustrated or it may be a separate entity. In FIG. 1, the data buffer 132 associated with the application processor 130 is coupled to the high-speed (HS) data buffer 120 and to the second transceiver 112 by a common bus 104. The associated data buffer 132 is coupled to the low-speed (LS) port 124 of the HS data buffer by the common data bus 104. The application processor is configured, for example, under software or firmware control, to control the transfer of data between the associated data buffer 132 and the high-speed data buffer 120. The application processor is also configured to control the transfer of data between the associated data buffer 132 and the LS transceiver 112.

In FIG. 1, the device 100 also comprises a controller 140 configured, for example, under software or firmware control, to control the transfer of data between the HS data buffer 120 and the HS transceiver 110. In FIGS. 1-3, the controller 140 is communicably coupled to the HS data buffer 120 including the HS port 122 thereof. The controller 140 is also communicably coupled to the application processor 130 and to the HS transceiver 110. In one particular mode of operation, data is transferred between the high-speed (HS) data buffer 120 and the associated data buffer 132 via the common data bus 104 at a rate that is less than a rate at which data is transferred between the HS transceiver 110 and the HS data buffer 120.

In the alternative embodiment of FIG. 2, the data buffer 132 associated with the application processor 130 is coupled to the LS port 124 by a data bus 204 and to the LS transceiver 112 by a separate data bus 206. In one implementation of the alternative embodiment, the application processor 130 is configured to transfer data between the associated data buffer 132 and the HS data buffer 120 at a rate that is greater than the rate at which data is transferred between the associated buffer 132 and the second transceiver 112. According to this embodiment, the bus 204 is a medium-speed bus and the bus 206 is a relatively low-speed bus.

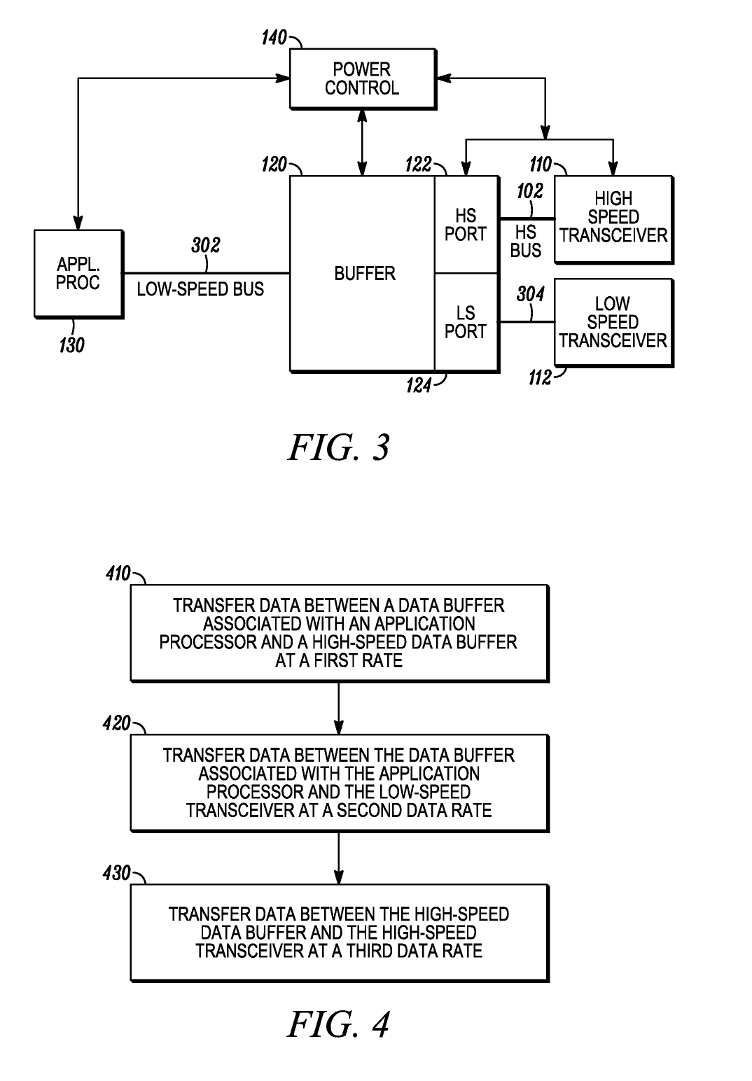

In the alternative embodiment of FIG. 3, a data buffer associated with the application processor 130 is coupled to the HS data buffer 120 by a low speed data bus 302. The HS port 122 is coupled to the HS transceiver 110 by the HS data bus 102 and the LS port 124 is coupled to the LS transceiver 112 by a LS data bus 304. In this embodiment, the LS data bus 304 may be faster than the data bus 302.

Generally, the elements of the transceiver architectures of FIGS. 1-3 may be discrete or partially or fully integrated. In FIG. 1, for example, the high-speed buffer 120 and the high-speed transceiver 110 may be part of a common integrated circuit. Alternatively, the controller 140 may also be integrated with the high-speed transceiver and the high-speed buffer. In another implementation, the application processor 130 and associated memory 132 may also be integrated with the high-speed memory 120 and HS transceiver 110. Other integration configurations or combination may also be implemented. For example, it may be possible in some applications to integrate the first and second transceivers on a common integrated circuit.

In one application, the controller 140 is configured to enable the first transceiver based on an amount of data in the high-speed data buffer. For example, in any one of the embodiments of FIGS. 1-3, data is transferred from the buffer 132 associated with the application processor 130 to the HS data buffer 120. During this buffering process, the HS transceiver 110 may be operated in a low power consumption state to conserve power. For example, in the low power state, the HS transceiver may be disabled or may be operated in a sleep mode or in a standby mode under the control of the controller 140 to reduce power consumption. In FIGS. 1-3, data is transferred to and buffered by the HS data buffer 120 at a relatively low transfer rate relative to the rate at which the HS transceiver is capable of transmitting the data. The low transfer rate may be limited for example by the processing capability of the application processor 130. When data in the HS data buffer accumulates to some specified quantity or level, the controller enables the HS transceiver for transmission of the data in the HS buffer. For example, in one embodiment the controller enables the HS transceiver when the HS buffer exceeds 75% of its capacity. In another embodiment, the controller enables the HS transceiver if the time without a HS transmission exceeds a time threshold, even if the HS buffer has not exceeded the buffer capacity threshold. This latter embodiment addresses the issue of data never being transmitted if the data buffer is below capacity, for example, at 25% capacity, for an extended time. The time threshold may be selected to meet Quality of Service (QoS) requirements. Upon transmission of the data buffered in the HS buffer, the HS transceiver may be returned to the low power consumption state until the more data has been transferred to the HS buffer for transmission by the HS transceiver.

In one embodiment, the controller may also be configured to disable the HS transceiver upon expiration of a data transfer period of the first transceiver. The expiration of a data transfer period terminates the high speed transfer after a set time rather than when the buffer is empty. For example, transmitting until expiration of a data transfer period, the high speed data may transfer 200 ms out of every minute. Such an approach may be desirable for regulatory or transceiver co-existence or power consumption reasons. At the end of 200 ms, the transceiver stops transmitting, and the remaining buffered data is transmitted during the next period.

In another application, the controller 140 is configured to enable the first transceiver based on an amount of data received by the second transceiver. For example, in the embodiments of FIGS. 1 and 2, data received by the LS transceiver is transferred to the buffer 132 associated with the application processor 130 via the data bus 104 in FIG. 1 or by the bus 204 in FIG. 2. According to this application, the HS transceiver and the HS data buffer is enabled based upon the information received by the LS transceiver. In this case, the LS transceiver may be used as a control channel. The two devices use the LS transceiver to agree when to turn on/off the high speed transceiver. It may be a single message, or there may be handshaking to ensure the other side is ready to receive the HS data and indicate when ready.

In another application, the controller 140 is configured to disable the first transceiver based on an amount of data in the high-speed data buffer, for example, when the buffer is full or near capacity. In the embodiments of FIGS. 1-3, data received by the HS transceiver is transferred to the HS data buffer 120. The rate at which data is received and transferred to the HS buffer may be greater than a rate at which the data is transferred from the HS buffer to some other entity, for example, to the application processor 130. In this application, the HS transceiver may be disabled when the data accumulated in the HS buffer reaches some threshold value. The HS transceiver may remain disabled until the data is transferred from the HS buffer to some other entity, for example, to the application processor 130. In this context, disabling of the HS transceiver includes disabling at least a receive function thereof. When the amount of data in the HS buffer drops to some lower level, the HS transceiver may again be enabled.

FIG. 5 is a process flow diagram in a portable wireless communication device the type having a form illustrated in FIG. 1-3. At 410, data is transferred between a data buffer associated with an application processor and a high-speed data buffer at a first rate. At 420, data is transferred between the data buffer associated with the application processor and the low-speed transceiver at a second data rate. At 430, data is transferred between the high-speed data buffer and the high-speed transceiver at a third data rate, wherein the first and second data rates are slower than the third data rate.

Generally, the data transfers among the various entities may occur at separate times, although the transfers may overlap. In one application, for example, data is transferred from the application processor data buffer to the high-speed data buffer while the high-speed transceiver is operated in a first power mode, for example, in a low power consumption mode. The high-speed transceiver is operated in a transmit power mode when an amount of data buffered in the associated buffer satisfies a condition, for example, when a specified amount of data is buffered. When in the transmit power mode, the high-speed transmitter transmits the data buffered in the high-speed data buffer. Thereafter, the high-speed transceiver reverts to the low power consumption mode until the amount of data in the high-speed data buffer satisfies the condition. In one implementation, the high-speed transceiver transmits the data in the high-speed data buffer during a data transfer period, whereupon the high-speed transceiver is disabled upon expiration of the data transfer period.

In another application, data received by the high-speed transceiver is transferred to the high-speed data buffer when the high-speed transceiver is enabled or operated in the receive mode. When the data in the high-speed buffer satisfies a condition, for example, when it is at or near capacity, the high-speed transceiver is disabled. In some embodiments, the data in the high-speed buffer is transferred to another entity, for example, to the application processor. Since the rate at which data is transferred from the high-speed memory to the application processor is less than the rate at which data is transferred to the high-speed memory, the high-speed data buffer will eventually become full. The high-speed transceiver may be disabled until a sufficient amount of data is transferred from the high-speed buffer whereupon the high-speed transceiver may be re-enabled.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A wireless communication device comprising:
a first transceiver;
a second transceiver;
a high-speed data buffer coupled to the first transceiver by a bus;
an application processor having an associated data buffer,
the data buffer associated with the application processor coupled to the high-speed data buffer and to the second transceiver by the bus,
the application processor configured to control the transfer of data between the associated data buffer and the high-speed data buffer, the application processor configured to control the transfer of data between the associated data buffer and the second transceiver.

2. The device of claim 1,
a controller configured to control the transfer of data between the high-speed data buffer and the first transceiver,
the application processor transfers data between the associated data buffer and the high-speed data buffer at a rate that is less than a rate at which the controller transfers data between the high-speed buffer and the first transceiver.

3. The device of claim 1,
a controller configured to control the transfer of data between the high-speed data buffer and the first transceiver,
the application processor transfers data between the associated data buffer and the second transceiver at a rate that is less than a rate at which the controller transfers data between the high-speed buffer and the first transceiver.

4. The device of claim 1, a controller communicably coupled to the high-speed data buffer and to the first transceiver, the controller configured to enable the first transceiver based on an amount of data in the high-speed data buffer.

5. The device of claim 1, a controller communicably coupled to the high-speed data buffer and to the first transceiver, the controller configured to enable the first transceiver based on information received by the second transceiver.

6. The device of claim 1, a controller communicably coupled to the high-speed data buffer and to the first transceiver, the controller configured to disable the first transceiver upon expiration of a data transfer period of the first transceiver.

7. The device of claim 1, a controller communicably coupled to the high-speed data buffer and to the first transceiver, the controller configured to disable the first transceiver based on an amount of data in the high-speed data buffer.

8. The device of claim 1, a controller communicably coupled to the high-speed data buffer and to the first transceiver, the controller configured to enable the first transceiver based on an amount of data transferred from the application processor to the high-speed data buffer for transmission by first transceiver.

9. The device of claim 8, the application processor configured to transfer data from the data buffer associated with the application processor via the common data bus at a rate that is less than a rate at which data is transferred from the high-speed data buffer to the first transceiver.

10. The device of claim 1, a controller communicably coupled to the high-speed data buffer and to the first transceiver, the controller configured to enable the first transceiver for reception based on an amount of data in the high-speed data buffer.

11. The device of claim 10, the application processor configured to transfer data between the high-speed data buffer and the associated data buffer via the common data bus at a rate that is less than a rate at which data is transferred between the first transceiver and the high-speed data buffer.

12. The wireless communication device of claim 1,
the high-speed data buffer has a first port and a second port,
the first transceiver is coupled to the first port of the high-speed data buffer by a first bus,
the data buffer of the application processor is coupled to the second port of the high-speed data buffer and to the second transceiver by a bus separate from the first bus.

13. The wireless communication device of claim 12,
the data buffer of the application processor is coupled to the second port of the high-speed data buffer by a second bus and to the second transceiver by a third bus,
the first bus transfers data at a rate greater than the second bus, and the second bus transfers data at a rate greater than the third bus.

14. A method in a portable wireless communication device including a high-speed data buffer coupled to a high-speed transceiver and an application processor having an associated data buffer coupled to the high-speed data buffer and to a low-speed transceiver, the method comprising:
transferring data between the data buffer associated with the application processor and the high-speed data buffer at a first data rate;
transferring data between the data buffer associated with the application processor and the low-speed transceiver at a second data rate;
transferring data between the high-speed data buffer and the high-speed transceiver at a third data rate,
the third data rate greater than the first and second data rates.

15. The method of claim 14,
transferring data from the associated data buffer to the high-speed data buffer while the high-speed transceiver is operated in a first power mode,
operating the high-speed transceiver in a second power mode when an amount of data buffered in the associated buffer satisfies a condition,
the first power mode consumes less power than the second power mode.

16. The method of claim 15, transmitting data buffered in the high-speed data buffer by the high-speed transceiver in the second power mode.

17. The method of claim 16, transmitting data buffered in the associated data buffer in the second power mode during a data transfer period, disabling the high-speed transceiver upon expiration of the data transfer period.

18. The method of claim 14,
transferring data received by the high-speed transceiver to the high-speed data buffer when the high-speed transceiver is enabled,
disabling the high-speed transceiver when an amount of data buffered in the associated buffer satisfies a condition.

19. The method of claim 14,
receiving information with the low-speed transceiver while the high-speed transceiver is disabled,
enabling the high-speed transceiver based on information received by the low-speed transceiver.
